(19) United States
(12) Patent Application Publication
(10) Pub. No.: US 2026/0056003 A1
(43) Pub. Date: Feb. 26, 2026

(54) LAYOUT DEVICE FOR RAILING RAIL MEMBERS

(71) Applicant: Chad HOLLENBECK, Berkshire, NY (US)

(72) Inventor: Chad HOLLENBECK, Berkshire, NY (US)

(21) Appl. No.: 19/234,877

(22) Filed: Jun. 11, 2025

Related U.S. Application Data
(60) Provisional application No. 63/685,405, filed on Aug. 21, 2024.

(51) Int. Cl. G01B 3/1056; G01B 3/08; G01B 3/1003; G01B 3/1007

(52) U.S. Cl. CPC G01B 3/1056; G01B 3/08; G01B 3/1003; G01B 3/1007; G01B 2003/1015

(57) ABSTRACT

A layout measuring device for railings or similar constructions that include upright or vertically parallel rail members such as balusters, pickets and spindles. The device includes a ruler including a plurality of spacing guides having a placement marker with a length that approximates a lateral length, perpendicular to the height, of one of the rail members so that the latter can be consistently and rapidly positioned along the railing construction to be created. The layout measuring device includes an arm adapted for equalizing a length between a first one of the rail members and a first post and a last one of the rail members and a second post. An upper surface of the ruler has a layout for positioning rail members along a surface parallel to a ground surface, and a lower surface of the ruler has a layout suitable for positioning rail members along an angled surface.

### FIELD OF THE INVENTION

This invention relates to a layout measuring device for railings or similar constructions that include upright or vertically parallel rail members such as balusters, pickets and spindles. The device includes a ruler comprising a plurality of spacing guides having a placement marker with a length that approximates a lateral length, perpendicular to the height, of one of the rail members so that the latter can be consistently and rapidly positioned along the railing construction to be created.

Still further, the layout measuring device includes an arm adapted for equalizing a length between a first one of the rail members and a first post and a last one of the rail members and a second post. The arm is operatively connected to and extendable and retractable from a first end of the ruler, the arm including a distal end adapted to be placed at an end of the first post, the arm including an arm ruler having an arm numerical scale.

In a preferred embodiment, an upper surface of the ruler has a layout for positioning rail members along a surface parallel to a ground surface, and a lower surface of the ruler has a layout suitable for positioning rail members along an angled surface.

### BACKGROUND OF THE INVENTION

In the building of railings, whether for railings with horizontal top and bottom rails and vertical rail members such as balusters, pickets, spindles and the like connected therebetween, or angled rails such as used on steps or other inclines, it is a requirement to mark out positions for the rail members. Most countries, states, and/or cities have code requirements that set a maximum permissible distance between adjacent rail members for safety.

Hand calculating required spacing is quite tedious and time consuming.

To make this task easier, various devices have been proposed in the art.

U.S. Pat. No. 927,110 relates to marking instruments, and more particularly to spacing instruments for marking siding etc., and has for its object to provide an instrument of this kind which may be adjusted to mark a plurality of points equidistant from each other, and which will be adjustable to vary the distance between the points marked.

U.S. Pat. No. 1,346,646 relates to measuring instruments, and it is the principal object of the invention to provide a novel form of dividing instrument whereby a surface or other article of work can be evenly divided into a plurality of parts; with markings being made on said surface or article of work in equidistant relation.

U.S. Pat. No. 1,428,582 relates to a device or instrument for ruling a multiple number of parallel lines simultaneously at equal distance apart, and in which by adjustment the amount of space between the lines can be varies to suit the requirements of the operator, and all movements of the ruling points will be simultaneously made and equal in amount, thus enabling the operator to rule a multiple number of parallel lines at any desired equal distance apart by means of one adjustment of the device.

U.S. Pat. No. 2,883,759 relates to a device for positioning a series of uniformly spaced parallel elements to meet varying requirement of slopes and distances. The invention is particularly adaptable for use in the construction of stairways, and more particularly to a device to aid in the layout and actual holding in position of the various elements of a stairway under construction or the holding of forms for the actual construction of concrete stairways or to act as an adjustable temporary stairway itself.

U.S. Pat. No. 3,157,953 relates to a measuring and marking apparatus. It provides an apparatus particularly applicable for measuring bars, plates and the like so as to automatically and selectively divide them into sections of equal length intermediate their extremities which may differ in length from equal portions defined thereby to their respective ends.

U.S. Pat. No. 6,854,196 relates to an adjustable spacer tool for spacing balusters that includes an extendable pantographic assembly having a first and second end and including evenly-spaced parallel uprights and X-shaped sets of cross-bars pivotally connected to one another. Each X-shaped set is pivotally connected to a pair of uprights adjacent upper ends thereof and pivotally and slidably connected to the upright's adjacent lower ends thereof. An arm, finger and cam extend outwardly from each end of the assembly to provide spacing between each end of the assembly and a desired surface for various sets of same-width balusters. Each arm is pivotally connected to one end of the assembly and to one end of the finger. The other end of the finger is pivotally and slidably connected to a respective end of the assembly. Each cam is pivotally connected to the arm distal the assembly. Removable connections permit adjustment of the overall length of the tool and replacement of parts.

Still other devices have been proposed in the construction field as templates or layout tapes utilized in spacing construction materials including, but not limited to, beams, joist and rafters, see for example U.S. Publication Nos. 2006/0096112 and 2008/0235973, and U.S. Pat. Nos. 2,187,087; 4,149,320; 5,012,590; and 6,494,014.

Even in view of the above examples of spacing devices and tools, the art still needs an easy-to-use layout measuring device for use in spacing upright rail members such as balusters, pickets and spindles or similar elements utilized in the construction of railings.

### SUMMARY OF THE INVENTION

The problems noted above and others are solved by the layout measuring device for rail members of the present invention, which allows a user to quickly and easily determine spacing for balusters, pickets and spindles or the like for railings. The layout measuring device includes a ruler having an arm connected to one end that is adapted for equalizing a length between a first rail member and a first post and a last of the rail members and a second post. To provide the required equal spacing, the arm is operatively connected to a first end of the ruler and has an arm ruler extendable and retractable from the first end of the ruler. Using the adjustable length arm, a user need only adjust the arm ruler so that the measurement thereon between the first post and first rail member is the same as the distance on a numerical scale of a spacing guide on the ruler between the last rail member and a second post.

In a preferred embodiment the layout measuring device has a ruler with a first side or upper surface to be utilized in conjunction with a horizontal surface and a second side or lower surface that can be utilized when measuring a layout for an angled surface, such as on a staircase or other incline.

In a first aspect a layout measuring device for railing rail members is disclosed, comprising a ruler having an upper surface, a lower surface, a first end at a second end, a width and a longitudinal length between the first end and the second end, wherein the ruler has a plurality of spacing guides on the upper surface including a first spacing guide and a second spacing guide adjacent to the first spacing guide along the longitudinal length, wherein the first and the second spacing guides each include a placement marker and a numerical scale that each extend in a longitudinal direction, wherein the placement marker has a first end and a second end with a length therebetween adapted to approximate a lateral length of a rail member, wherein the numerical scale has a first end and a second end, wherein one of a) the second end of the placement member is in contact with the first end of the numerical scale or b) the first end of the placement marker is in contact with the second end of the numerical scale; and an arm adapted for equalizing a length between a first one of the rail members and a first post and a last one of the rail members and a second post, the arm being operatively connected to the first end of the ruler, and having an arm ruler extendable and retractable from the first end of the ruler, the arm including a distal end adapted to be placed at an end of the first post, the arm ruler having an arm numerical scale.

In an additional aspect according to any of the above aspects, the first end of the placement marker of the first spacing guide begins at the first end of the ruler, and wherein the second end of the placement marker is in contact with the first end of the first numerical scale.

In a further aspect according to any of the above aspects, the arm ruler includes a first end and a second end, wherein the numerical scale begins at the first end of the arm ruler.

In still another aspect according to any of the above aspects, the arm numerical scale ends prior to the second end of the arm ruler.

In yet another aspect according to any of the above aspects, the ruler numerical scales and the arm numerical scale are less than or equal to 4 inches in length.

In an additional aspect according to any of the above aspects, the placement marker has a length that ranges from ⅛ inch to 12 inches.

In a further aspect according to any of the above aspects, a locking device selectively fixes and releases the arm ruler in relation to the ruler.

In still another aspect according to any of the above aspects, the locking device includes a thumb screw, and wherein the arm ruler includes a longitudinally extending slot, and wherein the ruler includes an aperture near the first end, and wherein a portion of the thumb screw extends through the arm slot and the ruler aperture.

In yet another aspect according to any of the above aspects, the ruler comprises a flexible tape.

In an additional aspect according to any of the above aspects, the ruler comprises a plurality of hinge segments.

In a further aspect according to any of the above aspects, the first spacing guide and second spacing guide are identical.

In still another aspect according to any of the above aspects, the ruler has a plurality of second spacing guides on the lower surface including a first lower spacing guide and a second spacing guide adjacent to the first lower spacing guide, wherein the first and the second lower spacing guides each include a lower placement marker and a lower numerical scale, wherein the lower placement marker has a first end and a second end with a length therebetween adapted to approximate a lateral length of the rail member, wherein the lower numerical scale has a first end and a second end, wherein one of a) the second end of the lower placement member is in contact with the first end of the lower numerical scale or b) the first end of the lower placement marker is in contact with the second end of the numerical scale; and wherein the arm ruler includes a lower arm numerical scale on a lower surface of the ruler.

In yet another aspect according to any of the above aspects, the placement marker length is greater than the length of the upper placement marker, and wherein the lower numerical scale length is greater than the length of the upper numerical scale in order to account for measuring rail members and spaces therebetween on an angle.

In an additional aspect according to any of the above aspects, the upper surface of the ruler is utilized for measuring a layout parallel to a ground surface and wherein the lower surface is utilized for measuring a layout at a non-parallel angle with respect to the ground surface.

For the avoidance of doubt, it is understood that while various embodiments or aspects of the invention are described individually, it should be clear that two or more embodiments or aspects can be, and often times are, present in a single device according to the present invention.

### BRIEF DESCRIPTION OF THE DRAWINGS

The invention will be better understood, and other features and advantages will become apparent by reading the detailed description of the invention, taken together with the drawings, wherein:

FIG. 1 is a perspective view of one embodiment of a layout measuring device of the present invention particularly illustrating a plurality of spacing guides and an arm adapted for equalizing spacing of rail members for a rail layout;

FIG. 2 is a top view of a further embodiment of a layout measuring device comprising a ruler having a plurality of hinged segments, wherein the ruler has a plurality of spacing guides and an arm operatively connected to the first end of the ruler adapted for equalizing spacing of rail members for a rail layout;

FIG. 3 is an illustration showing one method for using a layout measuring device according to the invention, wherein a distal end of a ruler of the arm of the layout measuring device is placed at an end of the first post and a plurality of rail members are aligned with the plurality of placement markers present on the ruler;

FIG. 4A is a side view of a further embodiment of a layout measuring device of the present invention;

FIG. 4B is an exploded view of one embodiment of a length equalizing arm connected to a first end portion of a ruler, based on the embodiment shown in FIG. 4A;

FIG. 5A is a side view of a further embodiment of a layout measuring device of the present invention including an arm adapted for equalizing length between a first rail member and first post and a last rail member and a second post;

FIG. 5B is an upper perspective view illustrating a first end portion of a ruler having a length equalizing arm operatively connected thereto based on FIG. 5A;

FIG. 5C is a lower perspective view of the embodiment illustrated in FIG. 5A showing the bottom surface of the ruler having a layout for spindles used on a stair railing or the like;

### DETAILED DESCRIPTION OF THE INVENTION

This description of preferred embodiments is to be read in connection with the accompanying drawings, which are part of the entire written description of this invention. In the description, corresponding reference numbers are used throughout to identify the same or functionally similar elements. Relative terms such as “horizontal,” “vertical,” “up,” “upper”, “down,” “lower”, “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and are not intended to require a particular orientation unless specifically stated as such. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship.

Layout measuring devices for rail members such as, but not limited to, balusters, pickets and spindles are described herein. The layout measuring devices include a ruler that includes for example a flexible tape or a plurality of hinged segments. Flexible tapes can be stored in a housing or enclosure and rolled and unrolled therefrom. The ruler has a plurality of spacing guides each including a placement marker and a numerical scale that extend in a longitudinal direction. The placement marker includes indicia that illustrates where a particular rail member is to be placed in a layout for a rail or other construction. Each layout measuring device includes a length equalizing arm connected to a first end portion of the ruler, with the arm having an arm ruler being operatively extendable and retractable from the first end of the ruler in order to provide consistent and rapid spacing between a first rail member and a last rail member to be located adjacent a first post and a second post, respectively.

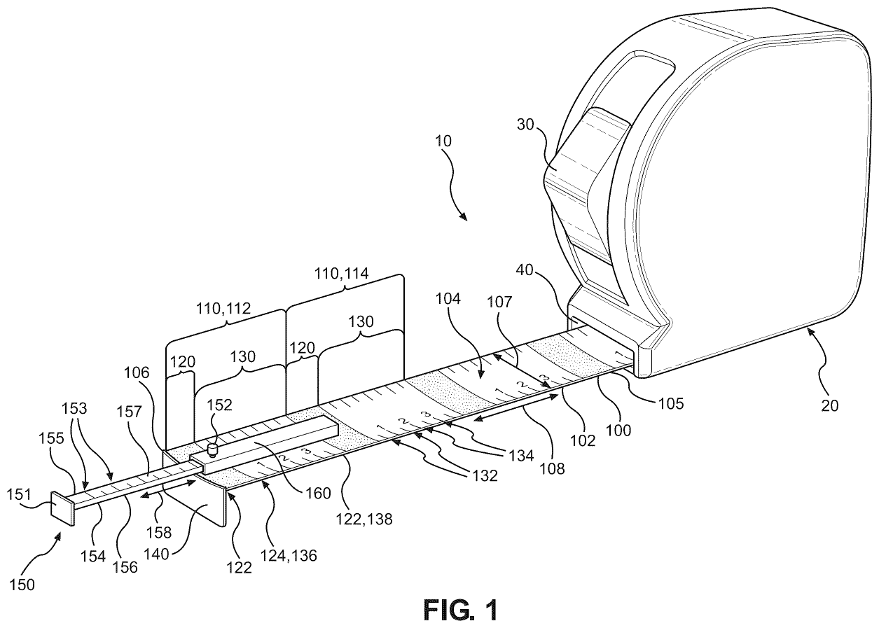

Referring now to the drawings, wherein like parts or represented by like reference numbers throughout the several views, FIG. 1 discloses one embodiment of a layout measuring device 10 including a housing 20 and a ruler 100 in the form of a flexible tape 102. Housing 20 includes a lock 30 that fixes or otherwise maintains ruler 100 in a desired position. Such locking devices are well known in the art. Flexible tape 102 is extendable and retractable from housing 20 through opening 40. Ruler 100 includes upper surface 104, lower surface 105, first end 106, and a second end located within housing 20. Ruler 100 also has a width 107 and a longitudinal length 108 between the first end 106 and the second end (not shown). The ruler has a plurality of spacing guides 110 on the upper surface 104 including a first spacing guide 112 and a second spacing guide 114 directly adjacent the first spacing guide 112 along the longitudinal length 108.

Each spacing guide 110 includes a placement marker 120 and a numerical scale 130 that each extend in the longitudinal direction.

The placement marker 120 indicates where a rail member such as baluster, picket or spindle, etc. is to be placed in a layout for a railing or other construction. In a preferred embodiment the placement marker has a length in the longitudinal direction that is equal or substantially equal to the length of the rail member in the longitudinal direction, which is generally perpendicular to the vertical height of the rail member.

The placement marker has a first end 122 and a second end 124 with a length therebetween adapted to approximate length of the rail member.

Preferably, the placement marker is a graphic image or other indicia that is readily distinguishable from the numerical scale. The graphic images can be made distinctive by color or other construction in order to stand out from the numerical scale. Colored shading is illustrated in FIG. 1. The placement markers may be shaded and numbered so that the user can reference how many rail members are needed in a particular railing section

Numerical scale 130 includes a plurality of gradations 132 and preferably one or more numbers 134. The gradations relate to the measurement scale such as metric measurements or the U.S. customary system, imperial system or standard system. In one preferred embodiment, the numerical scale 130 is four inches in length or less, for example in order to comply with various regulations regarding the maximum spacing between rail members for railings.

The numerical scale has first end 136 and a second end 138. In a preferred embodiment one of a) the second end 124 of the placement member 120 is in contact with the first end 136 of the numerical scale 130 or b) the first end 122 of the placement marker is in contact with the second end 138 of the numerical scale 130.

The placement marker has a length that ranges from ⅛″ to 12 inches. Preferably, the placement marker has a length in the longitudinal direction that is 0.75 inch, 1.25 inches, or 1.5 inches, although other lengths can be used.

The layout measuring device 10 also includes an end stop 140 which prevents ruler 100 from being drawn or retracted completely into housing 20. End stop 140 is also useful for withdrawing ruler 100 from within housing 20.

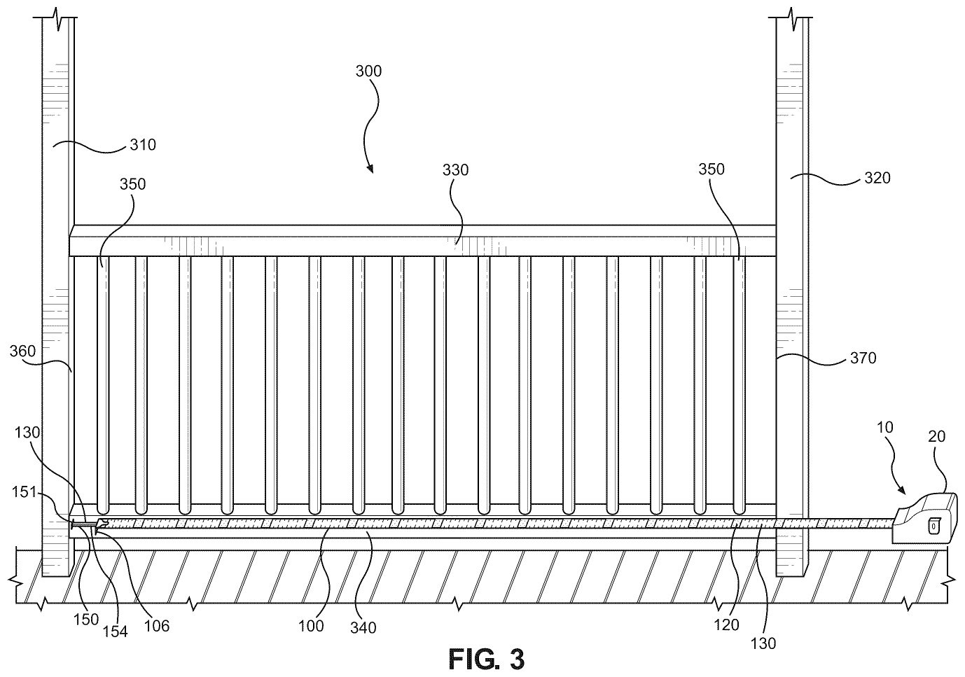

The layout measuring device 10 also includes an arm 150 that is adapted for equalizing a length between a first rail member 350 and a first post 310 and a last one of the rail members 350 and a second post 320, shown in FIG. 3. Arm 150 is operatively connected to the first end 106 of ruler 100 and has an arm ruler 154 extendable and retractable from the first end 106. The arm 150 includes a distal end 151 adapted to be placed at an inner end of the first post. The arm includes an arm numerical scale 153. The arm numerical scale 153 includes a plurality of gradations and preferably one or more numbers. The gradations relate to the measurement scale such as metric measurements or the U.S. customary system, imperial system or standard system. In one preferred embodiment, the arm numerical scale 153 is four inches in length or less when the ruler has a layout for positioning rail members along a surface parallel to a ground surface. The numerical scale can be longer than 4″ in length when the ruler has a layout suitable for positioning rail members along an angled surface.

In embodiment illustrated in FIG. 1, arm 150 ruler 154 is extendable and retractable from housing 160 that is fixedly connected to ruler 100. Arm 150 includes an upper surface 155, a lower surface 156, a second end, a width 157 and a longitudinal length 158 parallel to the longitudinal length of ruler 100. Arm ruler 154 is independently adjustable on ruler 100 in order to set a particular length between first end 151 and first end 106 of the ruler 100 which is adapted to be equal to the length as compared to the numerical scale 130 between a last one of the placement markers 120 or rail members and a second post so that the layout of the rail members is symmetrical between the first post and the second post, see FIG. 3 for example. For the avoidance of doubt, it should be clear that the longitudinal length 158 of arm ruler 154 can vary and is not limited to any particular length. Longer arm rulers are typically utilized when the device is adapted for use when positioning rail members along an angled surface.

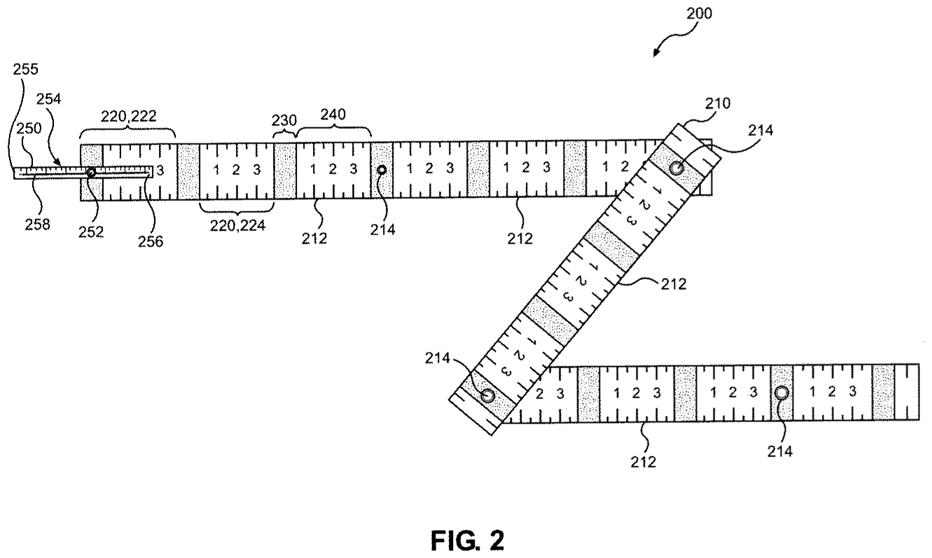

FIG. 2 illustrates a second embodiment of a layout measuring device 200 having a ruler 210 that comprises a plurality of hinge segments 212. The hinge segments 212 are connected via pins 214 or other suitable connectors about which each hinge segment 212 can rotate in order to form a ruler having a desired longitudinal length.

Like layout measuring device 10, layout measuring device 200 also includes a plurality spacing guides 220 on the upper surface including a first spacing guide 222 and a second spacing guide 224. The spacing guides include a placement marker 230 and a numerical scale 240 analogous to placement marker 120 and numerical scale 130 described above.

Layout measuring device 200 includes adjustable equalizing arm 250 extendable and retractable from ruler 210. Arm 250 includes a ruler 254 having a first end 255 that is adapted to be placed at the inner end of a first post. The arm 250 includes a slot 256 which allows ruler to be moved along the slot in relation to thumb screw 252. Thumb screw 252 can be tightened in order to fix arm ruler 254 in a set position once a desired measurement has been achieved utilizing measurement scale 258 of arm ruler 254.

In order to illustrate one method of using the layout measuring devices of the present invention, FIG. 3 shows a layout setup 300. Layout setup 300 includes a first post 310, second post 320 spaced a distance from first post 310. An upper rail 330 extends between posts 310 and 320. A lower rail 340 also extends between the posts 310 and 320. Layout measuring device 10 is used to determine layout for rail members 350. To do so, first end 151 of arm ruler 154 of arm 150 is placed against an inner end of first post 310 which abuts the first ends of upper rail 330 and lower rail 340. Preferably, the arm 150 arm ruler 154 is extended an arbitrary distance, perhaps it's 2″, from first end 106 of ruler 100 and locked in place with a thumb screw or any other form of locking mechanism. Then, the user places the extended first end 151 of the arm 150 against the first post 310. The ruler 100 is then extended until it reaches the inner side 370 of the second post 320.

The user then reads the relevant numerical scale 130, between the last represented spindle placement 120 on measuring tape 100 and the first side 370 of the second post 320. The length preset on the arm numerical scale 153 and numerical scale 130 adjacent the second post are determined.

If the length measurements are not equal, the user then adds 1) the length or distance on the numerical scale 153 preset on the extendable arm ruler 154 between first end 151 and first end 106 of ruler 100, and 2) the length or distance on the numerical scale 130 present between the last represented placement marker 120 second edge 124 on tape 100 and the second post's 320 inner side 370. As shown in FIG. 3 once those two numbers are added, then the user divides the sum by two. The number resulting from the division of the sum by two is the correct amount of space the user can then set on the arm numerical scale 153. The user then locks the extendable ruler arm 154 in place past the first end 106 of ruler 100, to the determined distance of division. Then, the user can abut the tip 151 against the inner side 360 of post 310. Once set, the numerical scale 153 on arm 150 past the first end 106 of ruler 100, is the distance between the inner side 360 of post 310 and the first side of the first rail member 350. That numerical scale will be equal to the distance between the side 370 of the second post 320 and the second side of the last rail member 350. The remaining rail members 350 can be then placed in the layout setup 300 at each placement marker.

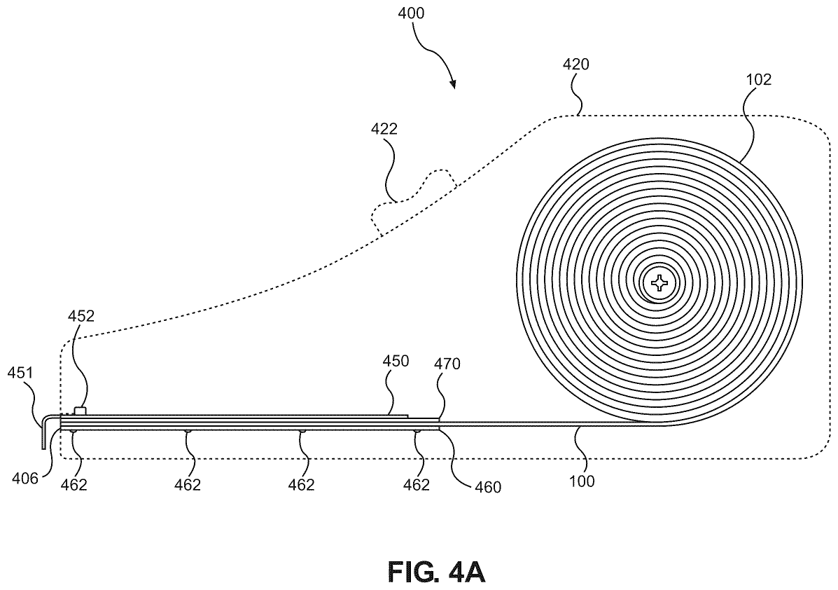

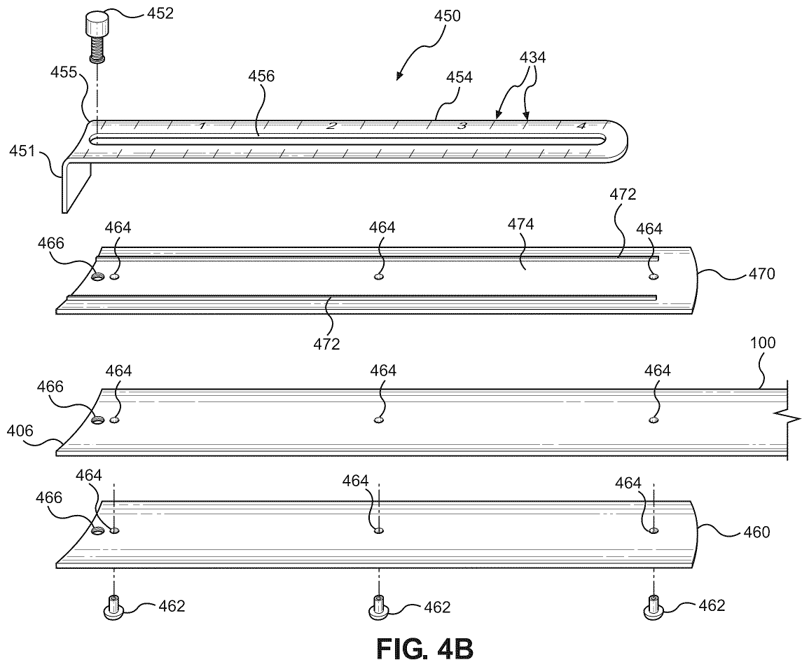

FIG. 4A is side view of a further embodiment of a layout measuring device 400 of the present invention. The device includes a housing 420, a locking devise 422 and a ruler 100 in the form of a flexible tape 102 that can be rolled and unrolled from housing 420, with a rolled condition being illustrated in FIG. 4A. An equalizing arm 450 is operatively attached to first end 406 of ruler 100. FIG. 4B shows an exploded view of the components of the equalizing arm 450 and ruler 100 shown on the left side of FIG. 4A.

Equalizing arm 450 is operatively connected to ruler 100 through connecting structure including base 460 and guide 470 which are connected to ruler 100 through fastener 462 which can be for example a rivet. Fastener 462 extends through base 460, ruler 100 and guide 470. Fastener 462 extends through apertures 464 in each piece. Guide 470 includes a pair of guide rails 472 which form a slot or channel 474 therebetween along which ruler 454 of arm 450 is movable in the longitudinal direction. Equalizing arm 450 ruler 454 has a first end 455. Arm 450 ruler 454 includes a slot 456 which allows the ruler to be moved along the guide 470 in relation to thumb screw 452 or another form of locking device. Thumb screw 452 can be tightened in order to temporarily fix ruler 454 in a set position once a desired measurement has been achieved utilizing measurement scale 434. Thumb screw 452 extends through threaded holes 466.

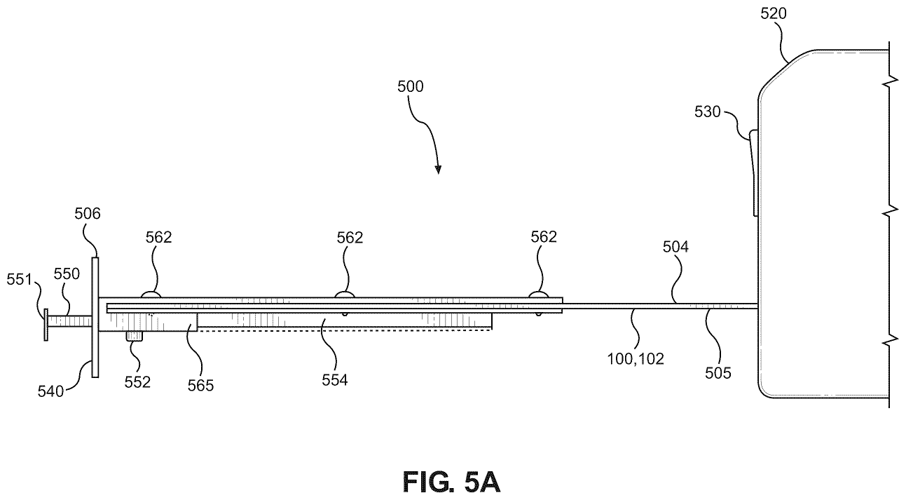

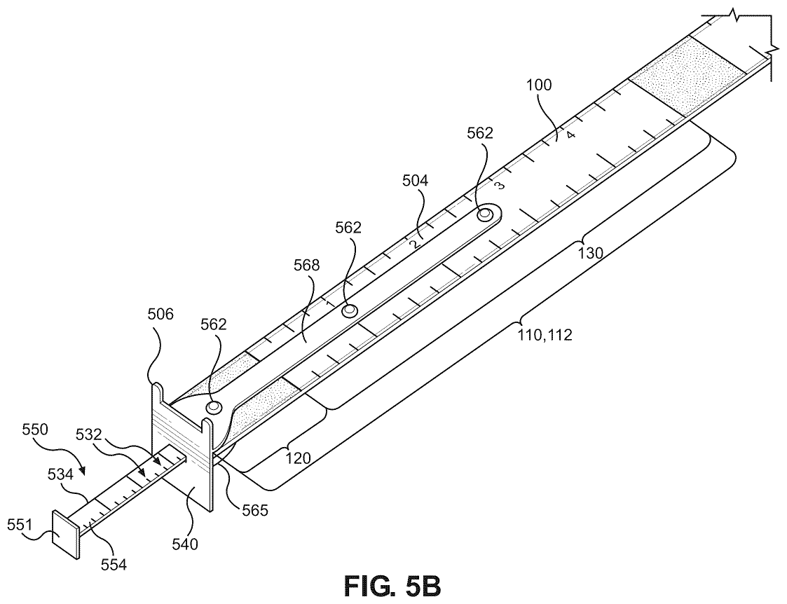

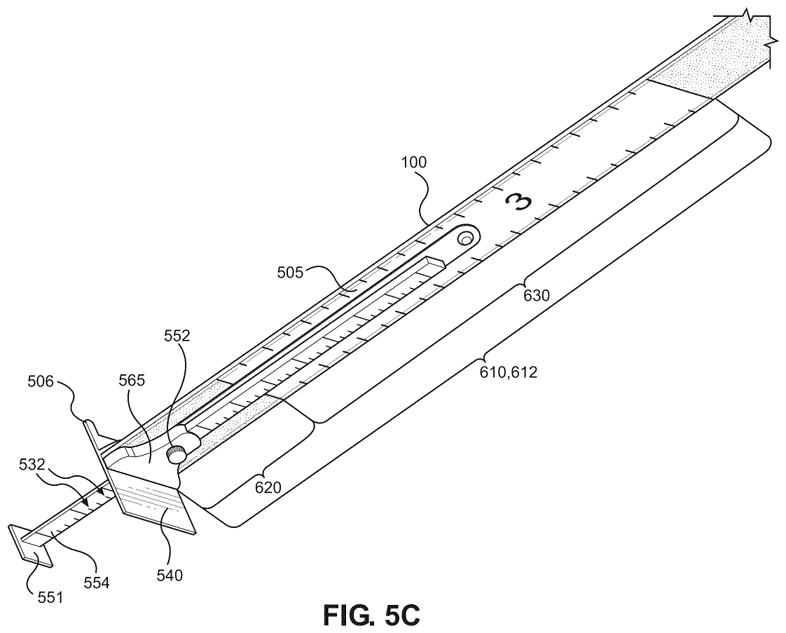

FIG. 5A-5C illustrate a further embodiment of a layout measuring device 500 of the present invention including an arm 550 adapted for equalizing the length between a first rail member and a first post and a last rail member and a second post. FIG. 5A illustrates a side view. FIG. 5B shows the layout on the supper surface 504 of the ruler 100 that is particularly useful for layouts where the upper rail and lower rail are horizontal to a ground surface. FIG. 5C illustrates a layout for positioning rail members along an angled surface such as a staircase. In this embodiment, the extendable arm 550 is operatively connected to a lower side 505 of ruler 100. Operation of layout measuring device 500 is the same as in the embodiments set forth above.

FIG. 5A shows an additional embodiment of a layout measuring device 500 including a housing 520 having ruler 100 extendable and retractable therefrom. Housing 520 includes a lock 530 that fixes or otherwise maintains ruler 100 in a desired position. Ruler 100 is formed of a flexible tape that includes an upper surface 504, lower surface 505, first end 506, and a second end located within housing 520.

FIG. 5B shows a top view and FIG. 5C shows a bottom view of ruler 100 of layout measuring device 500. The ruler 100 has a plurality of spacing guides 110 on the upper surface 504 including a first spacing guide 112, which additional spacing guides are not shown. Spacing guide 110 includes a placement marker 120 and a numerical scale 130 that each extend in a longitudinal direction. As with the other embodiments, the placement marker indicates where the rail member is to be placed in a layout.

FIG. 5C shows a bottom view of ruler 100 having a plurality of spacing guides 610 on lower surface 505 including a first spacing guide 612, wherein additional spacing guides are not shown. Spacing guide 610 includes a placement marker 620 and a numerical scale 630 each extending in a longitudinal direction. The scale used on the lower surface 505 has a longer placement marker and numerical scale as compared to the equivalent on upper surface 504 as the lower surface 505 is adapted to be utilized for a layout suitable for positioning rail members along an angled surface. The lengths of the lower placement marker and lower numerical scale will vary depending upon the angle of incline upon which the rail members are to be utilized.

The layout measuring device 500 also includes an end stop 540 which prevents ruler 100 from being drawn or retracted completely into housing 520. End stop 540 is also useful for withdrawing ruler 100 from within housing 520.

Layout measuring device 500 also includes an arm 550 adapted for equalizing the length between a first rail member and a first post and a last one of the rail members and a second post. Arm 550 is operatively connected to an extendable and retractable from first end 506 of ruler 100. Arm 550 includes a distal end 551 adapted to be placed at an inner end of the first post. Arm 550 includes arm ruler 554 having an arm numeral scale 534 including a plurality of gradations 532 such as described above. Arm 550 ruler 554 is extendable and retractable from arm housing 565 that is fixedly connected to ruler 100 for example using fasteners 562. A thumb screw 552 or other form of locking device can be tightened in order to fix arm ruler 554 in a set position once a desired measurement has been achieved utilizing numerical scale 534. Furthermore, there is a top plate 568 that is placed on the upper surface 504 of ruler 100 for support of the arm assembly. And secondly there is a bottom plate 570 also fixed to the lower surface 505 of ruler 100. Plates 570 and 568 are both for fastening the arm 550 to ruler 100 with customarily used fasteners 562.

For the avoidance of doubt, the devices and methods of the present invention encompass all possible combinations of the components, including various ranges of said components, disclosed herein. It is further noted that the term ‘comprising’ does not exclude the presence of other elements. However, it is also to be understood that a description of a product comprising certain components also discloses a product consisting of these components. Similarly, it is also to be understood that a description on a process comprising certain steps also discloses a process consisting of these steps.

In accordance with the patent statutes, the best mode and preferred embodiment have been set forth; the scope of the invention is not limited thereto, but rather by the scope of the attached claims.

What is claimed is:

1. A layout measuring device for railing rail members, comprising:
a ruler having an upper surface, a lower surface, a first end at a second end, a width and a longitudinal length between the first end and the second end,
wherein the ruler has a plurality of spacing guides on the upper surface including a first spacing guide and a second spacing guide adjacent to the first spacing guide along the longitudinal length,
wherein the first and the second spacing guides each include a placement marker and a numerical scale that each extend in a longitudinal direction,
wherein the placement marker has a first end and a second end with a length therebetween adapted to approximate a lateral length of a rail member,
wherein the numerical scale has a first end and a second end,
wherein one of a) the second end of the placement member is in contact with the first end of the numerical scale or b) the first end of the placement marker is in contact with the second end of the numerical scale; and
an arm adapted for equalizing a length between a first one of the rail members and a first post and a last one of the rail members and a second post, the arm being operatively connected to the first end of the ruler, and having an arm ruler extendable and retractable from the first end of the ruler, the arm including a distal end adapted to be placed at an end of the first post, the arm ruler having an arm numerical scale.

2. The device according to claim 1, wherein the first end of the placement marker of the first spacing guide begins at the first end of the ruler, and wherein the second end of the placement marker is in contact with the first end of the first numerical scale.

3. The device according to claim 1, wherein the arm ruler includes a first end and a second end, wherein the numerical scale begins at the first end of the arm ruler.

4. The device according to claim 3, wherein the arm numerical scale ends prior to the second end of the arm ruler.

5. The device according to claim 1, wherein the ruler numerical scales and the arm numerical scale are less than or equal to 4 inches in length.

6. The device according to claim 5, wherein the placement marker has a length that ranges from ⅛ inch to 12 inches.

7. The device according to claim 1, further including a locking device that selectively fixes and releases the arm ruler in relation to the ruler.

8. The device according to claim 7, wherein the locking device includes a thumb screw, and wherein the arm ruler includes a longitudinally extending slot, and wherein the ruler includes an aperture near the first end, and wherein a portion of the thumb screw extends through the arm slot and the ruler aperture.

9. The device according to claim 1, wherein the ruler comprises a flexible tape.

10. The device according to claim 1, wherein the ruler comprises a plurality of hinge segments.

11. The device according to claim 1, wherein the first spacing guide and second spacing guide are identical.

12. The device according to claim 1, wherein the ruler has a plurality of second spacing guides on the lower surface including a first lower spacing guide and a second spacing guide adjacent to the first lower spacing guide,
wherein the first and the second lower spacing guides each include a lower placement marker and a lower numerical scale,
wherein the lower placement marker has a first end and a second end with a length therebetween adapted to approximate a lateral length of the rail member,
wherein the lower numerical scale has a first end and a second end, wherein one of a) the second end of the lower placement member is in contact with the first end of the lower numerical scale or b) the first end of the lower placement marker is in contact with the second end of the numerical scale; and
wherein the arm ruler includes a lower arm numerical scale on a lower surface of the ruler.

13. The device according to claim 12, wherein the lower placement marker length is greater than the length of the upper placement marker, and wherein the lower numerical scale length is greater than the length of the upper numerical scale in order to account for measuring rail members and spaces therebetween on an angle.

14. The device according to claim 12, wherein the upper surface of the ruler is utilized for measuring a layout parallel to a ground surface and wherein the lower surface is utilized for measuring a layout at a non-parallel angle with respect to the ground surface.

15. The device according to claim 1, wherein the ruler has a plurality of alternative spacing guides on the upper surface including a first alternative spacing guide and a second alternative spacing guide adjacent to the first alternative spacing guide along the longitudinal length,
wherein the first and the second alternative spacing guides each include an alternative placement marker and an alternative numerical scale that each extend in a longitudinal direction,
wherein the alternative placement marker has a first end and a second end with a length therebetween adapted to approximate a lateral length of a rail member,
wherein the alternative numerical scale has a first end and a second end,
wherein one of a) the second end of the alternative placement member is in contact with the first end of the alternative numerical scale or b) the first end of the alternative placement marker is in contact with the second end of the alternative numerical scale, and
wherein the alternative spacing guides are different as compared to the plurality of spacing guides.
